(19) United States
(12) Patent Application Publication
(10) Pub. No.: US 2009/0030800 A1
(43) Pub. Date: Jan. 29, 2009

(54) Method and System for Searching a Data Network by Using a Virtual Assistant and for Advertising by using the same

(75) Inventor: Dan Grois, Beer-Sheva (IL)

Correspondence Address: Dan Grois, 64 Mivtza Nahshon street, apartment 33, Beer-Sheva, 84451, IL

(73) Assignee: Dan Grois, Beer-Sheva (IL)

(21) Appl. No.: 12/223,483

(22) PCT Filed: Jan. 31, 2007
(86) PCT No.: PCT/IL07/00121

§ 371 Date: Jul. 31, 2008

(30) Foreign Application Priority Data
Feb. 1, 2006 (IL) 173493
Mar. 5, 2006 (IL) 174107

(51) Int. Cl. G06Q 30/00; G06F 7/06; G06F 17/30

(52) U.S. Cl. 705/14; 707/5; 707/E17.108

(57) ABSTRACT

The present invention relates to a method, system and server configured to enable a plurality of users to conduct a data search within a database over a data network, comprising: (a) a first software component for enabling one or more of the following: (a.1.) providing a user with a user interface, having a virtual assistant, for enabling said user to conduct a data search over a data network by means of said virtual assistant; and (a.2.) receiving data from said user interface, having said virtual assistant, and conveying corresponding data back to said user to be provided to him by means of said virtual assistant; (b) a second software component for enabling said virtual assistant to interact with said user; and (c) a third software component for: (c.1.) enabling receiving from said user at least one search query by means of said virtual assistant; (c.2.) enabling analyzing and processing said at least one search query for determining one or more data items from a plurality of data items stored and/or indexed within a search database, said one or more data items being relevant to said at least one search query, giving rise to relevant data items being the search results; and (c.3.) enabling providing at least a portion of said search results to said user by means of said virtual assistant, each search result being provided as the relevant data item or as a link to said relevant data item.

### FIELD OF THE INVENTION

The present invention relates to search engines. More particularly, the invention relates to a method and system for conducting an optimized search within a database over a data network by using a virtual assistant that provides users with search results according to their search queries and further provides them with advertisements according to their fields of interest.

### BACKGROUND OF THE INVENTION

For the last decade, the Internet has grown significantly due to the dramatic technology developments. Surfing the Internet has become a very simple and inexpensive task, which can be afforded by everyone. Due to the ISDN® (Integrated Services Digital Network®) and ADSL® (Asymmetric Digital Subscriber Line®) technology, people surf the World Wide Web (WWW) with the speed of up to 12 Mbits per second, which allow them to obtain search results of their queries for less than a second. A number of new Web sites over the Internet, which go online every month, has also significantly increased over the last decade. Each of main search engines over the World Wide Web crawls nowadays billions of documents. However, all search engines implemented on the prior art technology have not been originally developed for handling and searching such huge amount of information, and therefore over the years they have failed to provide efficient search results for users' queries.

Generally, prior art databases and search engines implement textual User Interfaces. A user wishing to search the prior art database has to input one or more textual queries. However, the most natural way for the user to search the database and communicate with search engines is by “making a voice or video conversation” with said search engines and providing to said search engines natural queries and commands, such as voice, image, pictures, photos, video, multimedia queries and commands, similarly to a real conversation between two or more people. The prior art fails to provide search engine users with such capabilities and fails to provide them with an intelligent search engine User Interface. For example, US 2003/0171926 discloses an information retrieval system for voice-based applications enabling voice-based content search. The system comprises a remote communication device for communication through a telecommunication network, a data storage server for storing data and an adaptive indexer interfacing with a speech recognition platform. Further the adaptive indexer is coupled to a content extractor. The adaptive indexer indexes the contents in configured manner, and the local memory stores the link to the indexed contents. The speech recognition platform recognizes the voice input with the help of a dynamic grammar generator, and the results thereof are encapsulated into a markup language document. Another patent, U.S. Pat. No. 7,027,987, presents a system that provides search results from a voice search query. The system receives a voice search query from a user, derives one or more recognition hypotheses, each being associated with a weight, from the voice search query, and constructs a weighted boolean query using the recognition hypotheses. The system then provides the weighted boolean query to a search system and provides the results of the search system to a user. However, neither US 2003/0171926 nor U.S. Pat. No. 7,027,987 teach providing users with a “smart” User Interface having a virtual assistant that communicates with the user like a human being, enabling each user to search the database by using voice, video, image, pictures, photos, and audio search queries, similarly to a real conversation between two or more people. In addition, they do not teach advertising over a database by using said “smart” User Interface having said virtual assistant and by using user's conventional Web camera. Without providing in the near future an efficient search engine with an intelligent User Interface that functions as a Virtual Assistant of each search engine user, providing said each user with a natural communication environment, people soon will not be able to find anything from among billions and trillions of documents.

The main source of monetary income for search engines is advertising. Usually, an advertiser wishing to advertise his one or more products to search engine users, places on the search engine Web site a “Sponsored Link” forwarding a user clicking on said “Sponsored Link” to a Web site, wherein said user can purchase said one or more products. Each time the user clicks on said “Sponsored Link”, the advertiser pays a predetermined sum of money to the search engine provider. This action is named “Pay Per Click” (or PPC). The more clicks are provided by users of the search engine Web site, the larger monetary income is obtained by the search engine provider. Alternatively, the search engine provider can charge the advertiser a fixed daily or monthly sum of money for each “Sponsored Link” presented to the search engine user. However, the users often click on “Sponsored Links” because of curiosity and not because of intension to purchase advertised products. As a result, advertisers pay a lot of money to search engine providers for nothing, since only a small percentage of all search engine users clicking on the “Sponsored Links” finally purchase advertised products.

Therefore, there is a need to overcome the above prior art drawbacks.

It is an object of the present invention to enable a user to easily communicate with a search engine by providing to said user a natural communication environment.

It is another object of the present invention to provide a method and system for providing a user with an intelligent User Interface, enabling said user easily communicate with a search engine by making natural search queries, such as voice, image, pictures, photos, video, audio queries, similarly to a real conversation between two or more people.

It is still another object of the present invention to provide a method and system for providing a search engine user with a Virtual Assistant, which converse with said user and enables him to obtain the most appropriate search results for his one or more search queries.

It is still another object of the present invention to provide a method and system for the search engine advertising by using a Virtual Assistant that provides search engine users with advertisements according to their fields of interest.

It is a further object of the present invention to provide a method and system for the search engine advertising, wherein users' fields of interest are determined by using a conventional Web camera.

It is still a further object of the present invention to provide a method and system, which is user friendly.

Other objects and advantages of the invention will become apparent as the description proceeds.

### SUMMARY OF THE INVENTION

The present invention relates to a method and system for conducting an optimized search within a database over a data network by using a virtual assistant that provides users with search results according to their search queries and further provides them with advertisements according to their fields of interest.

The system for conducting a data search within a database over a data network comprises: (a) a user interface having a virtual assistant for communicating with a user, for receiving from said user one or more search queries and for providing to said user one or more corresponding search results from said database; and (b) one or more software components installed on a server connected to said database and/or installed on a user's computer for: (b.1.) enabling said virtual assistant to communicate with said user; (b.2.) analyzing and processing said one or more search queries for obtaining corresponding search results; and (b.3.) processing said one or more search results and providing them to said user.

The system for providing one or more advertisements to a user conducting a data search within a database over a data network comprises: (a) a user interface having a virtual assistant for communicating with a user, for receiving from said user one or more search queries and for providing to said user one or more advertisements related to his one or more search queries; and (b) one or more software components installed on a server connected to said database and/or installed on a user's computer for: (b.1.) enabling said virtual assistant to communicate with said user; (b.2.) analyzing and processing said one or more search queries for obtaining corresponding one or more advertisements; and (b.3.) processing said one or more advertisements related to said one or more search queries and providing them to said user.

According to a preferred embodiment of the present invention, the data search is selected from one or more of the following: (a) a video search; (b) a graphic, image, picture, photo, icon or logo search; (c) a voice search; (d) an audio search; (e) a data file search; and (f) a textual search.

According to a preferred embodiment of the present invention, the one or more advertisements are selected from one or more of the following: (a) a video advertisement; (b) a graphic, image, picture, photo, icon or logo advertisement; (c) a voice advertisement; (d) an audio advertisement; (e) a data file advertisement; and (f) a textual advertisement.

According to a particular preferred embodiment of the present invention, the one or more advertisements are provided according to a category or subcategory of the one or more search queries.

According to another particular preferred embodiment of the present invention, the one or more advertisements are provided according to a category or subcategory of one or more search results for user's one or more search quires.

According to a preferred embodiment of the present invention, the virtual assistant communicates with the user by presenting to him data selected from one or more of the following: (a) voice data; (b) audio data; (c) video data; (d) image, picture, photo, graphic, icon or logo data; and (e) textual data.

According to a preferred embodiment of the present invention, the virtual assistant receives a response from the user to the presented data and provides to said user the one or more advertisements based on said response.

According to a preferred embodiment of the present invention, the one or more software components use one or more members within the group, comprising: (a) speech recognition; (b) audio recognition; (c) visual recognition; (d) OCR recognition; (e) object recognition; and (f) face recognition.

According to a preferred embodiment of the present invention, the one or more user's search queries are provided by means of a camera connected to the data network.

According to another preferred embodiment of the present invention, the virtual assistant determines user's characteristics and/or user's mood by means of the camera.

According to still another preferred embodiment of the present invention, the virtual assistant determines objects and their one or more characteristics by means of the camera, said objects physically located within the space where the user searches the database.

According to still another preferred embodiment of the present invention, the camera field of view is not constant and is changing for determining objects within the space, wherein the user searches the database.

According to still another preferred embodiment of the present invention, a search engine provider controls the field of view of each camera, connected to the data network, by means of one or more software and/or hardware components or units.

According to a particular preferred embodiment of the present invention, the one or more user's search queries are provided as data files.

According to a particular preferred embodiment of the present invention, the virtual assistant makes the one or more advertisements to the user based on other users' one or more reviews.

According to a preferred embodiment of the present invention, the user prior to conducting the data search within the database, discusses with the virtual assistant one or more issues related to said data search.

According to another preferred embodiment of the present invention, the user writes and/or records a review for each document within the one or more search results.

According to a preferred embodiment of the present invention, the virtual assistant is implemented by utilizing artificial intelligence.

According to a preferred embodiment of the present invention, the artificial intelligence utilizes one or more members within the group, comprising: (a) one or more neural networks; (b) one or more decision making algorithms and techniques; (c) case-based reasoning; (d) natural language processing; (e) speech recognition; (f) one or more understanding algorithms and techniques; (g) one or more visual recognition algorithms and techniques; (h) one or more intelligent agents; (i) one or more machine learning algorithms and techniques; (j) fuzzy logic; (k) one or more genetic algorithms and techniques; (l) automatic programming; and (m) computer vision.

According to another preferred embodiment of the present invention, the virtual assistant discusses with the user one or more documents within the one or more search results, or reads, or shows to the user data related to each document, said data based on contents of each corresponding document or based on the contents of a site to which said each corresponding document is related.

According to still another preferred embodiment of the present invention, the user interface is the artificial intelligence based interface allowing the user to interact with a computer-based system similarly to conversing with a human being.

According to still another preferred embodiment of the present invention, the user sets one or more preferences of the virtual assistant.

According to still another preferred embodiment of the present invention, the virtual assistant provides to the user data related to each document within the database, said data selected from one or more of the following: (a) anchor text; (b) category; (c) wording; (d) textual data; (e) graphical data; (f) URL parameters; (g) creation data; (h) update data; (i) author data; (j) meta data; (k) owner data; (l) statistic data; (m) history data; (n) one or more votes for said document; and (o) probability.

According to still another preferred embodiment of the present invention, the history data is selected from one or more of the following: (a) content(s) update(s) or change(s); (b) creation date(s); (c) ranking history; (d) categorized ranking history; (e) traffic data history; (f) query(is) analysis history; (g) user behavior history; (h) URL data history; (i) user maintained or generated data history; (j) unique word(s) usage history; (k) bigram(s) history; (l) phrase(s) in anchor text usage history; (m) linkage of an independent peer(s) history; (n) document topic(s) history; (o) anchor text content(s) history; and (p) meta data history.

The system for providing one or more advertisements to a user conducting a data search within a database over a data network comprises: (a) a camera for shooting a user and/or his environment and obtaining corresponding visual data; (b) one or more software components for receiving the obtained visual data and processing it; and (c) one or more software components for providing one or more advertisements to said user according to said obtained visual data.

The system for communicating with a user over a data network by means of a virtual assistant and providing to said user one or more advertisements comprises: (a) a camera for shooting a user and/or his environment and obtaining corresponding visual data; (b) one or more software components for receiving the obtained visual data and processing it; and (c) a virtual assistant for communicating with said user and providing to said user one or more advertisements according to said obtained visual data.

According to a preferred embodiment of the present invention, the visual data relates to a visual appearance of the user.

According to another preferred embodiment of the present invention, the visual data relates to one or more objects located in the camera field of view.

According to still another preferred embodiment of the present invention, the visual data relates to mood of the user.

According to still another preferred embodiment of the present invention, the visual data relates to user's one or more characteristics.

According to a preferred embodiment of the present invention, a type of the camera is selected from one or more of the following: (a) a video camera; (b) a photo camera; (c) an Infrared camera; (d) an ultraviolet camera; and (e) a thermal camera.

According to a preferred embodiment of the present invention, the virtual assistant is implemented by software and/or hardware.

According to a preferred embodiment of the present invention, the user responds to the one or more advertisements by one or more of the following: (a) a visual response; (b) a voice response; (c) an audio response; (d) a textual response; and (e) a data file response.

### BRIEF DESCRIPTION OF THE DRAWINGS

### In the Drawings:

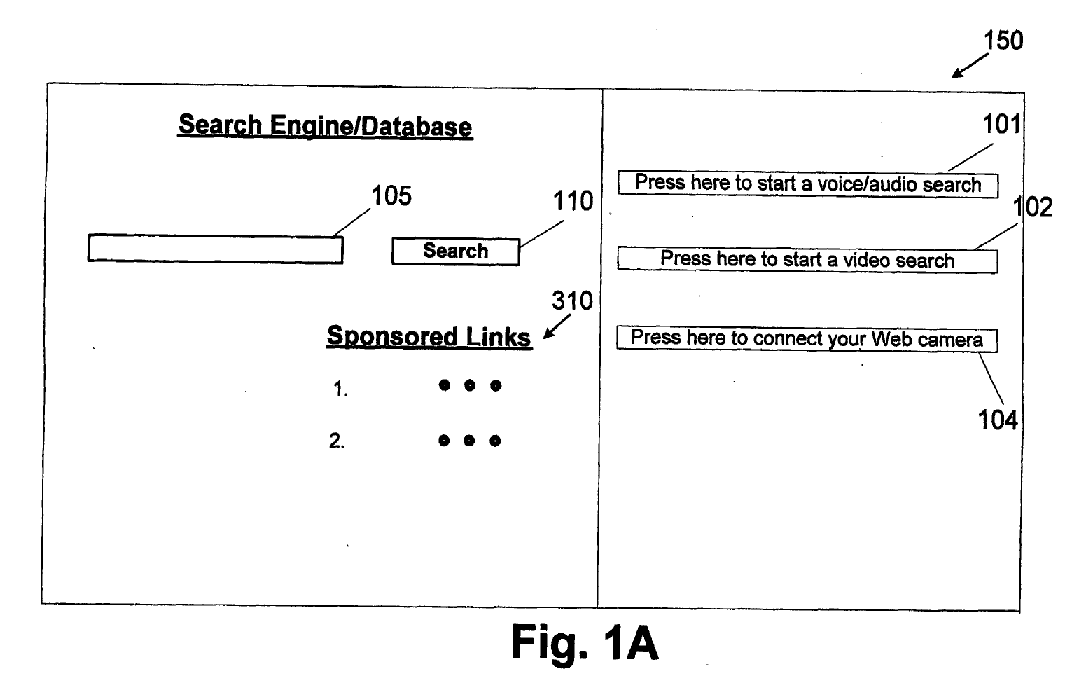

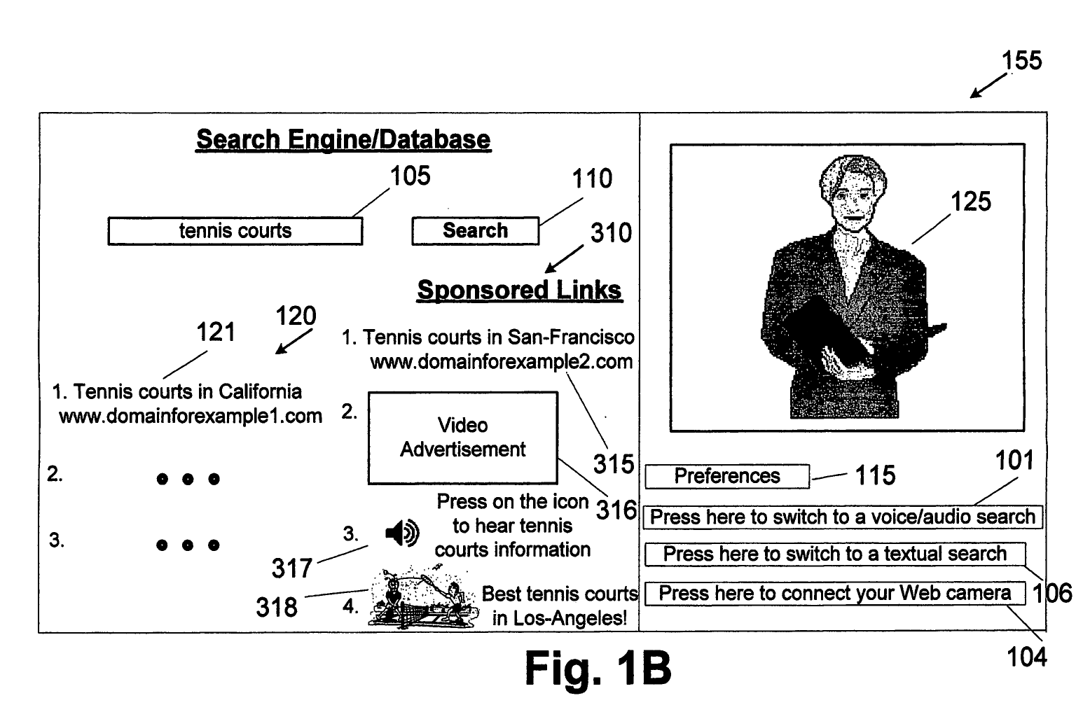

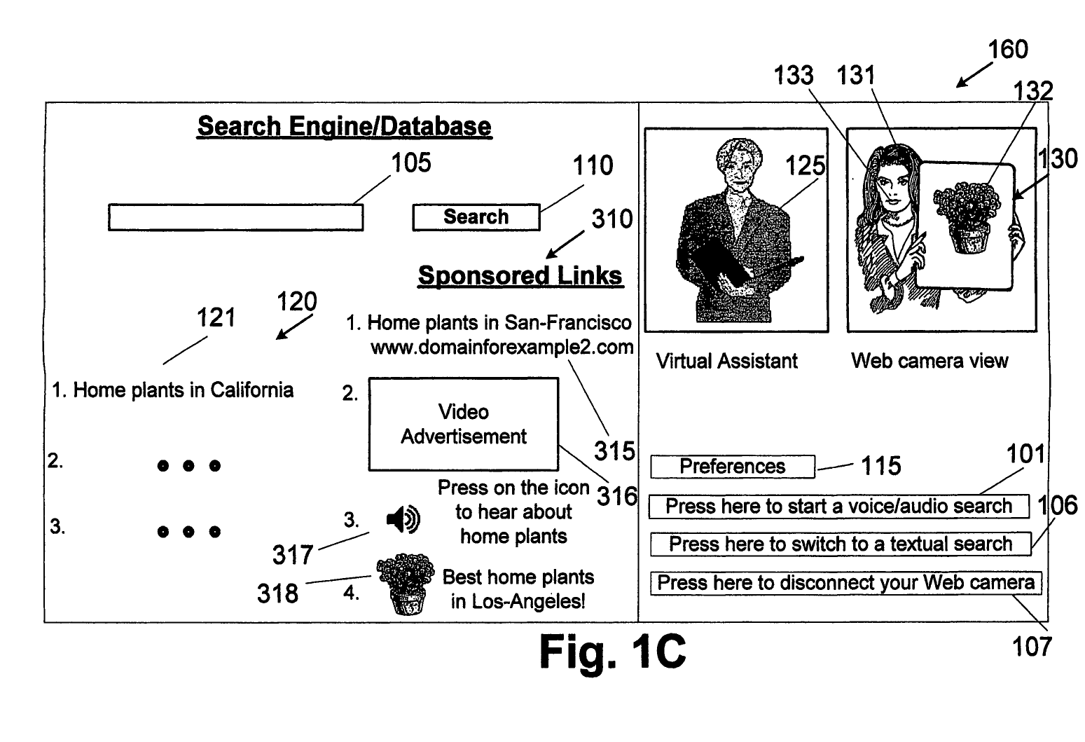

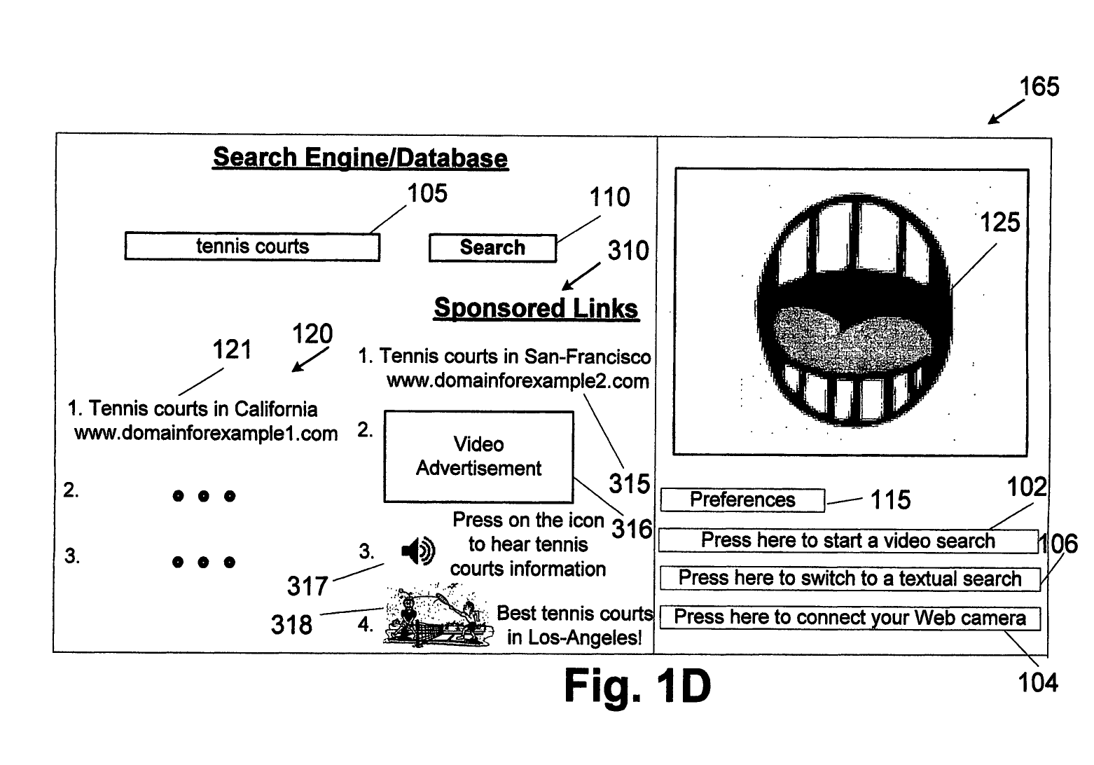

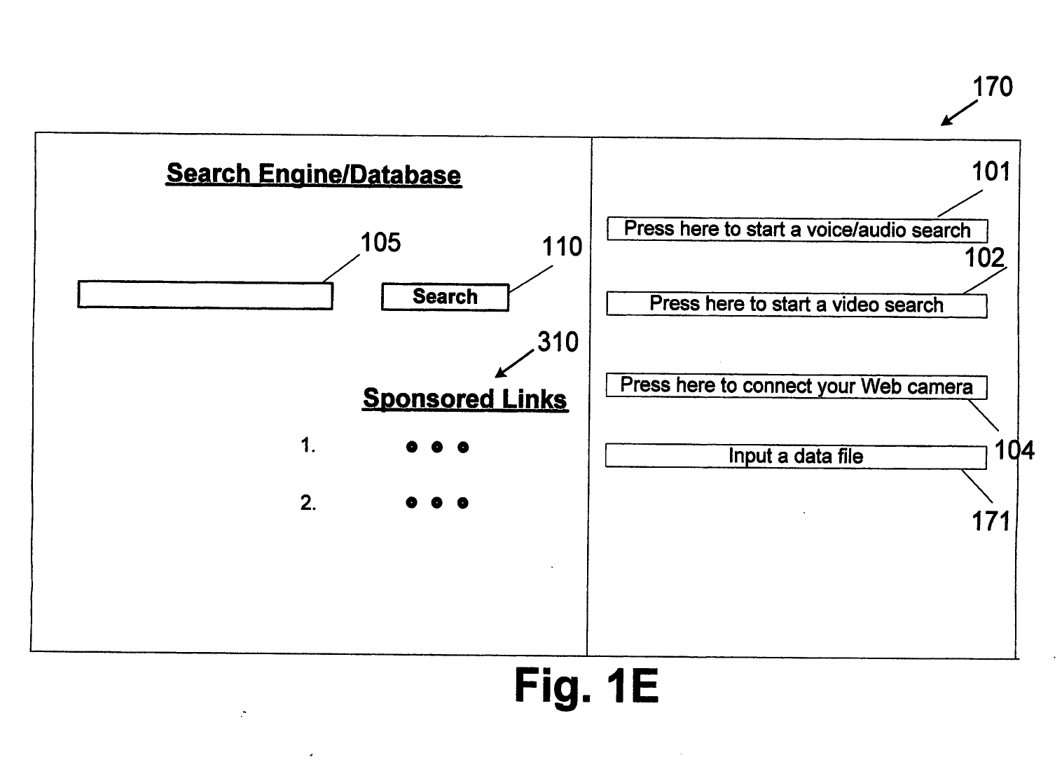

FIG. 1A is a schematic illustration of conducting an optimized data search within a database over a data network by using an intelligent User Interface, and of advertising by using the same, according to a preferred embodiment of the present invention;

FIG. 1B is a schematic illustration of conducting a video search within a database over a data network by means of a Virtual Assistant, and of advertising by using the same, according to a preferred embodiment of the present invention;

FIG. 1C is a schematic illustration of conducting a video search within a database over a data network by using an intelligent User Interface having a Virtual Assistant and by using user's video/photo camera, and of advertising by using the same, according to another preferred embodiment of the present invention;

FIG. 1D is a schematic illustration of conducting a voice search within a database over a data network by using a Virtual Assistant implemented within an intelligent User Interface, and of advertising by using the same, according to a preferred embodiment of the present invention;

FIG. 1E is a schematic illustration of conducting an optimized data search within a database over a data network by using an intelligent User Interface and enabling a user to use a data file related to his search (enabling a user to make a “data file search”), and of advertising by using the same, according to a preferred embodiment of the present invention;

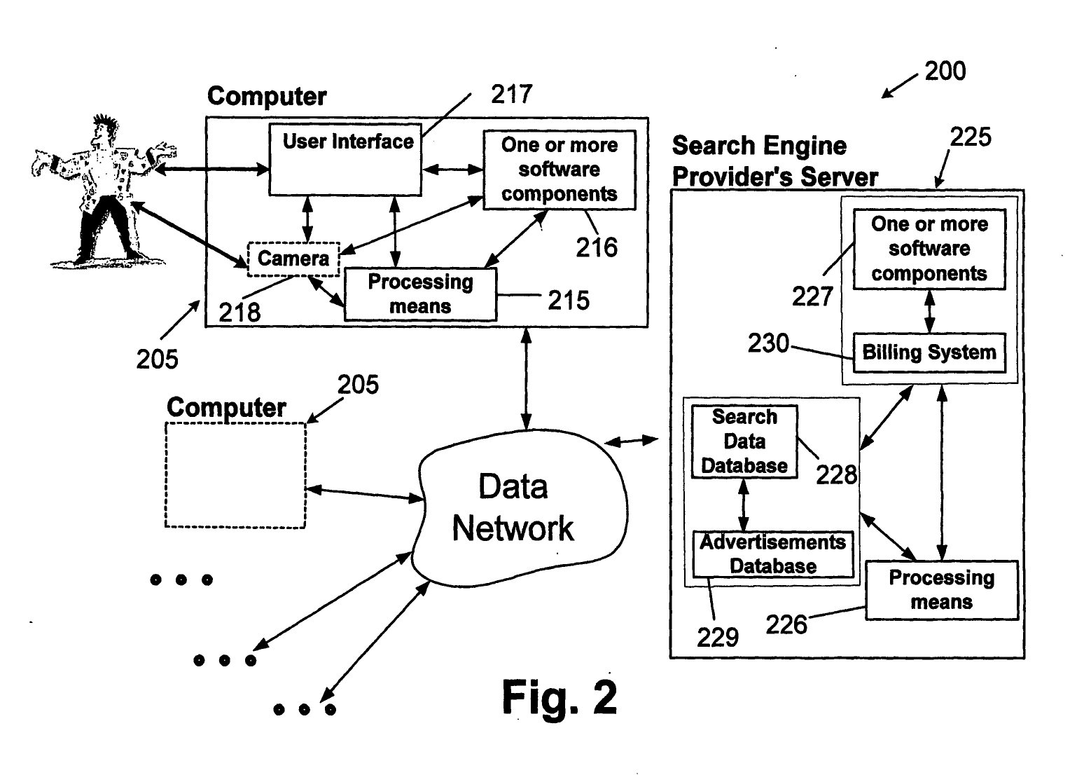

FIG. 2 is a schematic illustration of system for conducting optimized data searches within a database over a data network by using an intelligent User Interface having a Virtual Assistant, and for advertising by using the same, according to a preferred embodiment of the present invention; and

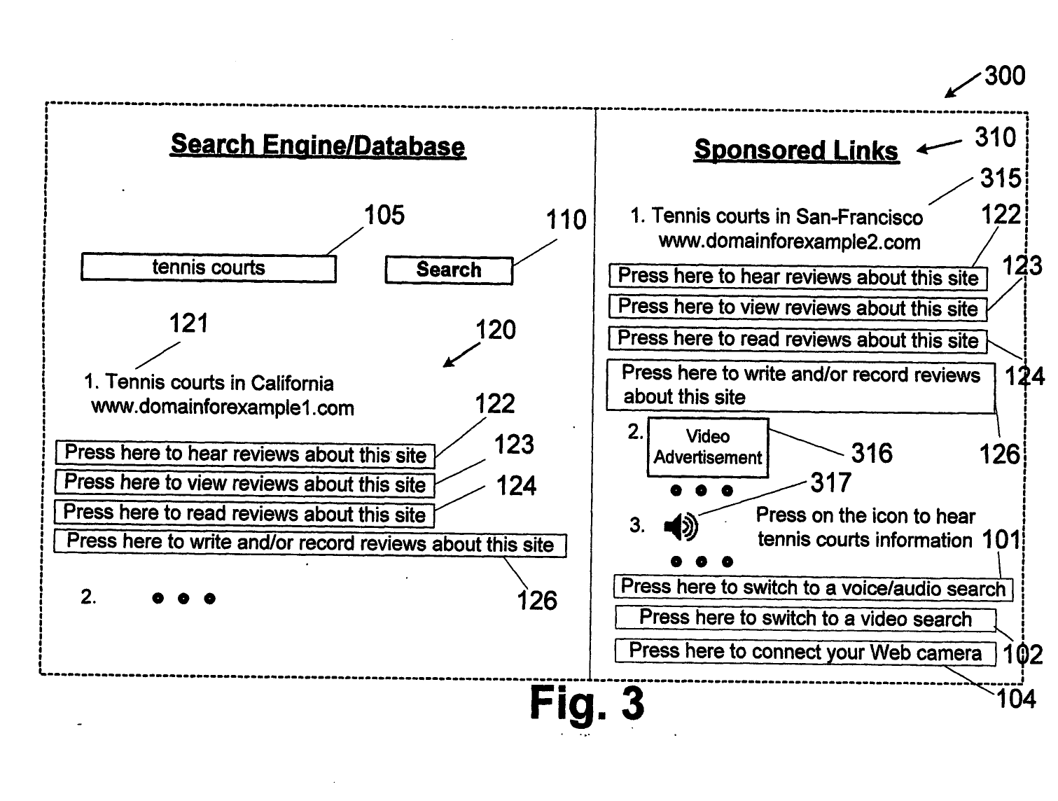

FIG. 3 is another schematic illustration of conducting an optimized data search within a database over a data network by using an intelligent User Interface having a Virtual Assistant, and of advertising by using the same, according to another preferred embodiment of the present invention.

### DETAILED DESCRIPTION OF THE PREFERRED EMBODIMENTS

Hereinafter, when the term “data search” or “search” (which are used interchangeably) is used, it refers to a search that is selected from the group and is any combination thereof, said group comprising: (a) a video search; (b) a graphic, image, picture, photo, icon or logo search; (c) a voice search; (d) an audio search; (e) a data file search; and (f) textual search. In addition, when the term “advertisement” is used, it refers to an advertisement that is selected from the group and is any combination thereof, said group comprising: (a) a video advertisement; (b) a graphic, image, picture, photo, icon or logo advertisement; (c) a voice advertisement; (d) an audio advertisement; (e) a data file advertisement; and (f) a textual advertisement. Furthermore, when the term “document” is used it should be noted that it also relates to the terms “page”, “Web page” and the like, which are used interchangeably. The term “document” can be broadly interpreted as any machine-readable and machine-storable work product. A page may correspond to a document or a portion of a document and vise versa. A page may also correspond to more than a single document and vise versa.

FIG. 1A is a schematic illustration 150 of conducting an optimized data search within a database over a data network by using an intelligent User Interface, and of advertising by using the same, according to a preferred embodiment of the present invention. A user, connected to a data network, such as the Internet, wireless network, etc. can perform a number of different searches: a voice/audio search 101, a video search 102 and a conventional textual search. In addition, the user can provide video data to said search engine by connecting a camera (such as a Web camera) to his computer, said data used for conducting a search and for providing to said user a corresponding list of Sponsored Links 310 and/or corresponding video or audio data related to said Sponsored Links and their contents. Also, the user can conduct a conventional textual search by inserting one or more text queries into a text field 105 and pressing a “Search” button 110. When conducting any type of the data search, the user is presented with a list of Sponsored Links 310 and/or with voice/audio, image/picture/photo/icon/logo or video data related to said Sponsored Links 310 and their contents, advertising various products, services, etc.

FIG. 1B is a schematic illustration 155 of conducting a video search within a database over a data network by means of a Virtual Assistant 125, and of advertising by using the same, according to a preferred embodiment of the present invention. The User Interface of the search engine comprises a Virtual Assistant means 125 (one or more software and/or hardware components or units) providing a user with a natural communication environment and helping said user to obtain the most appropriate search results for his one or more search queries. It is assumed, for example, that the user conducts a textual or voice (by providing queries by voice) search for a query “tennis courts”. The user receives a number of relevant search results 120, such as “Tennis courts in California” and etc. Virtual Assistant 125 can discuss with the user the received search results for obtaining the optimal search result. Virtual Assistant 125 can ask a user a number of questions related to user's search query, and by analyzing and processing user's answer(s) Virtual Assistant 125 can select the most appropriate search result(s) from a list of obtained search results 120. The user can communicate with Virtual Assistant 125 as with a human being, since said Virtual Assistant behaves as the human being. Virtual Assistant 125 analyzes user's voice queries, commands, answers and the like by means of one or more speech recognizing components, which are installed within search engine server and/or user's computer. Then, one or more software components, which can have an artificial intelligence (such as neural networks), process the analyzed data and ask the user by means of Virtual Assistant 125 one or more questions that help to determine the most appropriate search result for user's one or more queries. Sponsored Links 310 can be provided based on user's one or more search queries (voice and/or audio and/or video, etc. search queries), based on contents of the discussion between the user and Virtual Assistant 125, based on user's answers to said one or more questions, etc.

According to a preferred embodiment of the present invention, Sponsored Links 310 can be provided to the user by voice (speech) and/or by audio data; by displaying video and/or graphic, image, picture, photo, icon, logo or textual information; or by providing a data file, such as video, voice, multimedia file comprising data of said Sponsored Links 310. For example, can be provided: a textual link 315 “Tennis courts in San-Francisco www.domainforexample2.com”; a video link 316; an audio/voice link 317; and a picture/image/photo/icon/logo link 318.

The user, when clicking or responding (for example, by voice, by making a visual sign, such as a positive/negative nod of his head, etc.) to each provided Sponsored Link, is redirected to a document related to the advertised product, service or anything else. Each time the user clicks or responds to said “Sponsored Link”, the advertiser pays a predetermined sum of money to the search engine provider. The more clicks or responses are provided by the users at the search engine Web site, the larger monetary income is obtained by the search engine provider. Alternatively, the search engine provider can charge from the advertiser a fixed daily or monthly price for each “Sponsored Link” provided to the search engine user. If Sponsored Links are provided to the user, for example, by voice, audio or video, then said user can instruct Virtual Assistant 125 to surf to the corresponding Sponsored Link Web page. In addition, Virtual Assistant 125 can automatically surf to the corresponding Sponsored Link Web page upon receipt a positive response from the user, such as a positive nod of his head. At this case, the advertiser can be charged each time users surf to said Sponsored Link Web page.

Since Sponsored Links 310 can be based on processing and analyzing the discussion between the user and Virtual Assistant 125, said Sponsored Links 310 can be fitted exactly to user's needs, making advertising more efficient and effective and increasing advertisers' monetary income. The owner of each Sponsored Link (the advertiser who pays to the search engine provider for advertising) can select the range of keywords, categories or subcategories for which his Sponsored Link would be provided to the user. For example, it is assumed that the user during his discussion with Virtual Assistant 125 said the following passage: “I am studying electronics engineering at university, and I have many lectures on mathematics and physics. I feel that at my free time I need to learn more about Van Gogh art and seventeen century history; I need to learn something different.” Then, after the speech recognition component and another software component, having an artificial intelligence, process and analyze said passage, Sponsored Links related to art, history and other subjects of humanities and social sciences can be provided to the user. It should be noted that Sponsored Links related to mathematics and physics can not be provided, since the user according to said passage is not interested in these issues. For optimal results, only Sponsored Links related to Van Gogh art and seventeen century history can be provided to the user. However, also can be provided Sponsored Links related to the Picasso art, for example, if advertiser so wishes.

According to a preferred embodiment of the present invention, the artificial intelligence of the Virtual Assistant can be based, for example, on neural computing (neural networks); can implement different decision making algorithms and techniques; can implement case-based reasoning; can implement natural language processing (pattern matching, syntactic and semantic analysis, neural computing, conceptual dependency, etc.), and speech/audio recognition, and understanding algorithms and techniques; can implement visual recognition algorithms and techniques; can use intelligent agents; can implement fuzzy logic, genetic algorithms and techniques, automatic programming, computer vision, and many others. The Virtual Assistant can further implement various machine learning algorithms and techniques. The User Interface is the artificial intelligence based interface allowing the user to interact with a computer-based system in the same way (or in much the same way) as he would converse with another human being. The artificial intelligence of the Virtual Assistant can be implemented by means of software and/or hardware.

It should be noted that according to a preferred embodiment of the present invention, the user can set Virtual Assistant preferences 115, such as sex, age, voice tone, hair color, clothes, etc. The user can switch the video search to the voice search only, wherein Virtual Assistant 125 can be only heard but not seen, by pressing link 101 “Switch to a voice/audio search”. Similarly, the user can switch to a conventional textual search by pressing link 106 “Switch to a textual search”. In addition, the user can connect his Web camera to the search engine User Interface for providing video data conducting the search by pressing the corresponding link 104 “Connect my Web camera”.

According to a preferred embodiment of the present invention, the Virtual Assistant can discuss with the user the obtained search results 120 and/or recommend to him one or more search results within a plurality of search results 120. The Virtual Assistant recommendation(s) for a specific document can be based on users' reviews/votes of said document, statistics for visiting said document, the score of said document, document history, etc. The Virtual Assistant can tell the user about each document within the search results 120 based on the contents of said document and/or the Web site to which said document is related. In addition, the Virtual Assistant can show to the user pictures/images/photos/videos for each document based on the contents of said document and/or the Web site to which said document is related. The Virtual Assistant helps the user to determine which document within search results 120 is the most appropriate to the user's one or more search queries. The Virtual Assistant can recommend to the user to make another search or recommend using a specific keyword(s) for conducting another search. For enabling the Virtual Assistant to communicate with the user, various artificial intelligence algorithms and techniques can be implemented, such as neural networks, decision making algorithms and techniques, and many others. In addition, prior to conducting the search the user can discuss with Virtual Assistant 125 what he is interested (what he wishes) to find, and Virtual Assistant 125 helps said user to obtain the most appropriate search results based on user's interests (wishes).

According to another preferred embodiment of the present invention, Virtual Assistant 125 helps the user to perform a categorized search. The user says to the Virtual Assistant one or more categories in which he is interested to make a search, and Virtual Assistant 125 helps said user to obtain the optimal (the most appropriate) search results. The Virtual Assistant can ask the user one or more questions for better understanding of user's search queries. Alternatively, Virtual Assistant 125 can present to the user a list of available categories/subcategories, and the user selects from said list the most appropriate one or more categories/subcategories for his search.

According to still another preferred embodiment of the present invention, Virtual Assistant 125 is used for conducting a search, based on one or more categorized scores of each document within the database. The method for assigning one or more categorized scores to each document stored within a database over a data network is disclosed in IL 172551. According to a preferred embodiment of the present invention, Virtual Assistant 125 helps the user to find one or more documents within the database by using the corresponding categorized scores of said documents. In addition, Virtual Assistant 125 provides to the user one or more categorized scores of each document within the database. For example, if the user says, shows or provides to Virtual Assistant 125 a document (stored within a database) or its link as a software file, then said Virtual Assistant 125 provides to said user one or more categorized scores of said document. For another example, the user can request from Virtual Assistant 125 to display a list of all documents having an Educational rank of 9, 99 or 999, or to display a list of all documents having both an Educational rank of 99 and a Sport rank of 100. Virtual Assistant 125 can perform any task related to presenting to the user any database data, such as statistic data.

According to a preferred embodiment of the present invention, Sponsored Links category and/or subcategory is determined by analyzing and processing user's one or more search queries (voice and/or audio and/or video, etc. search queries), and/or contents of the discussion between the user and Virtual Assistant 125, and/or user's answers to one or more Virtual Assistant's questions. Then, one or more Sponsored Links, related to the determined category or subcategory, are provided to the user. The Sponsored Links are provided to the user by voice (speech) and/or by audio data, by displaying video and/or graphic, image, picture, photo, icon, logo or textual information, or by providing a data (software) file, such as video, voice, multimedia file comprising data of said Sponsored Links. For example, if the subcategory is the “Van Gogh art”, then all Sponsored Links related to art can be displayed. The Sponsored Links category and/or subcategory can be similar to the categorized score category of one or more documents 121 provided to the user as search results list 120 to his one or more queries, said categorized scores as disclosed in IL 172551. This can simplify determining each corresponding Sponsored Links category and/or subcategory.

According to a further preferred embodiment of the present invention, Virtual Assistant 125 provides to the user data related to each document within the database, such as history data, statistical data, etc. For example, Virtual Assistant 125 analyzes and provides to the user the following data related to each document: anchor text, category, wording, textual or graphical data (contents), URL parameters (such as URL wording, URL domain owner or registrar), creation or update data (such as creation or update date or time, age, etc.), author data, meta data, owner data, statistic data (such as users' number of clicks or responses), history data (such as users' past searches related to the document and/or to a page linking to said document and/or to a page linked from said document), a probability that said document is presented within search results, and any other parameters (properties). The history data of each document comprises: (a) content(s) update(s) or change(s); (b) creation date(s); (c) ranking history; (d) categorized ranking history; (e) phrase(s) in anchor text usage history; (f) document topic(s) history; (g) user behavior history; (h) meta data history; (i) user maintained or generated data history; (j) unique word(s) usage history; (k) bigram(s) history; (l) traffic data history; (m) linkage of an independent peer(s) history; (n) query(is) analysis history; (o) anchor text content(s) history; (p) URL data history; and etc. The statistic data of each document comprises document traffic data, average daily or monthly downloads of said document or from said document, etc. In addition, Virtual Assistant 125 can analyze and provide data related to votes of users for said document (such as “a good document” or “a bad document”) and/or reviews of said document of users who visited it.

It should be noted that according to all preferred embodiments of the present invention, Virtual Assistant 125 can be implemented not only for search engine/databases but also for any Web site, document, forum, portal, etc.

FIG. 1C is a schematic illustration 160 of conducting a video search within a database over a data network by using an intelligent User Interface having a Virtual Assistant 125 and by using user's video/photo camera, and of advertising by using the same, according to another preferred embodiment of the present invention. According to this preferred embodiment of the present invention, the user provides video data 130 to the search engine by means of his camera, such as a Web camera, as his one or more search queries. It can be assumed, for the example that user 131 is searching for a description and name of a specific plant 132. User 131 connects his Web video/photo camera to his computer, surfs to the search engine/database Web site and places a draft of said plant 132 in front of his Web camera. The draft of the plant is shot by the user's Web camera, then the image (photograph) is analyzed and processed by one or more software components within the search engine and/or within the user's computer, and then said plant is recognized. The search results (the name and the description of the plant) are presented to the user by voice, by video or audio, by text and/or by sending to the user one or more data files comprising the requested information.

For another example, it can be assumed that the user is searching for a description of a specific painting of Van Gogh, but he does not know the name of said painting. The user has a wall/desk calendar with a reproduction of said painting and he wishes to learn more about it. Then, said user connects his Web camera to his computer, surfs to the search engine Web site and places the painting in front of his Web camera. The painting is shot by said Web camera, then analyzed and processed by one or more software components installed within the search engine and/or installed within user's computer. Finally, the painting is recognized and its description is presented to the user.

It should be noted, that according to another preferred embodiment of the present invention, the one or more software components (for example, visual recognition software components) for processing and/or recognizing user's query data, such as the painting can be installed on user's computer before searching the database. A link for installing said one or more software components can be provided on the search engine Web site. Also, it should be noted that the camera can be of any type, such as a video camera, a photo camera, an Infrared camera, a thermal camera, an ultraviolet camera, etc.

According to a preferred embodiment of the present invention, Virtual Assistant 125 can determine characteristics of the user searching the database by means of user's camera, such as a Web camera and converse with said user accordingly. The characteristics of the user can comprise, for example, his visual appearance, such as his hair or eyes color, his body complexity (fat, skinny), etc. or to his mood (angry, smiley), his sex (male, female) and many others. In addition, the Virtual Assistant can determine objects, such as a closet, desk, shelf, books, etc. physically located within the room/space (environment) wherein the user searches the database, and located within the camera field of view. Virtual Assistant 125 can use the data related to user's characteristics and/or objects characteristics (such as their color, dimensions, contents, quantity, price, etc.) for providing to the user one or more advertisements, such as Sponsored Links 310. Sponsored Links 310 can be provided by voice (speech) and/or by audio data, by displaying video and/or graphic, image, picture, photo, icon, logo or textual information, or by providing a data file, such as video, voice, multimedia file comprising data of said Sponsored Links. For example, can be provided a textual link 315 “Home plants in San-Francisco www.domainforexample2.com”; a video link 316; an audio/voice link 317; and a picture/image/photo/icon/logo link 318. In addition, Virtual Assistant 125 can use the data related to user's and objects characteristics, when conversing with the user. For enabling this preferred embodiment of the present invention, one or more software components can be installed on search engine server 225 (FIG. 2) and/or on user's computer 205 (FIG. 2), said one or more software components comprising visual recognition techniques and algorithms, object/face recognition techniques and algorithms, etc. If user 131 smiles, for example, then the Virtual Assistant can ask said user “Why are you smiling?” or “I am glad that searching our database makes you happy!” If user 131 does not smile 133, then the Virtual Assistant can ask said user “What can I do to make you happy?” It should be noted, that the more sensitive user's Web camera is (the more sensitive is camera sensor), then the more precise can be the camera detection of user's characteristics. According to a preferred embodiment of the present invention, a color camera is used for determining a variety of user's characteristics, such as user's hair or eyes color, user's clothes color, etc. Each user's characteristic and/or characteristic of each object located within the room/space wherein said user searches the database, can be categorized and one or more Sponsored Links relates to the corresponding category can be provided to said user.

The user, when clicking or responding (for example, by voice, by making a visual sign, such as a positive/negative nod of his head, etc.) to each provided Sponsored Link, is redirected to a document related to the advertised product, service or anything else. Each time the user clicks or responds to said “Sponsored Link”, the advertiser pays a predetermined sum of money to the search engine provider. The more clicks or responses are provided by the users at the search engine Web site, the larger monetary income is obtained by the search engine provider. Alternatively, the search engine provider can charge from the advertiser a fixed daily or monthly price for each “Sponsored Link” provided to the search engine user. If Sponsored Links are provided to the user, for example, by voice, audio or video, then said user can instruct Virtual Assistant 125 to surf to the corresponding Sponsored Link Web page. In addition, Virtual Assistant 125 can automatically surf to the corresponding Sponsored Link Web page upon receipt a positive response from the user, such as a positive nod of his head. At this case, the advertiser can be charged each time the user surfs to said Sponsored Link Web page.

According to a preferred embodiments of the present invention, the user responds to the one or more advertisements by making a response selected from the group comprising: (a) a visual response that is shot by a video/photo Web camera (such as making a positive/negative nod of his head, placing in front of his camera a page, wherein is indicated, for example, “Yes” or “No” regarding advertised products, services, etc.); (b) a voice response; (c) an audio response; (d) a textual response; and (e) a data file response (by providing within said data file a positive/negative response; the data file can by of any type, such as textual, audio/voice, video/multimedia, etc.).

It should be noted, that according to a preferred embodiment of the present invention, the user's camera field of view is not constant and can be changed for determining a greater spectrum of objects within the room/space, wherein the user searches the database. The search engine provider can control the field of view of each camera (optionally, by receiving user's permission), connected to the data network, by means of one or more software and/or hardware components/units installed within each user's computer and/or server 225 of said search engine provider.

According to a preferred embodiment of the present invention, Virtual Assistant 125 also can determine details/properties of user's clothes. For example, it can determine whether the user is wearing a T-shirt or sweater and what is written/painted/drawn on the front section of said T-shirt. Virtual Assistant 125 can determine the writing on the user's T-shirt by one or more text recognition software components, such as OCR (Optical Character Recognition) software components. The Virtual Assistant can discuss with the user about user's determined characteristics, determined objects in the camera field of view and their details/properties, etc., and recommend (advertise) to the user one or more products within the database over the data network, which are related to said user's characteristics and/or objects details/properties. For example, if Virtual Assistant 125 by means of user's Web camera detects a book titled “MBA” (Master of Business Administration) on a shelf within the room/space wherein the user conducts the search, then said Virtual Assistant can provide to said user various information related to MBA, such as test preparation material for admitting MBA programs, a list of institutions having MBA courses, etc. The Virtual Assistant can determine user's location in the world (country, city, street, house and apartment number, etc.) by analyzing his IP (Internet Protocol) address and/or his IP provider, for example, and propose to said user to visit MBA institutions, which are located near his house or office. For another example, if the Virtual Assistant detected by means of user's Web camera that on user's T-shirt is written “Rock Party”, then said user can be provided with “Sponsored Links” related to rock parties taking place near the geographical (physical) location of said user. Said Sponsored Links are provided by voice (speech) and/or audio data, by displaying video and/or graphic, image, picture, photo, icon, logo or textual information, or by providing a data file, such as video, voice, multimedia file comprising data of said Sponsored Links. For still another example, Virtual Assistant 125 by means of user's Web camera detects a certain book or product for which a newer edition is available. Then, the search engine provider by means of said Virtual Assistant 125 presents to the user one or more Sponsored Links related to said newer book edition.

The Virtual Assistant can function as an advisor for users connected to said data network, providing to each user the most appropriate documents over the data network, according to users' interests and wishes.

The user can set within preferences 115 whether he wishes that the Virtual Assistant would make with him an official or friendly conversation. For example, if the user selects a “friendly conversation” option within preferences 115, then Virtual Assistant 125 can ask the user how he feels today, what is bothering him, whether he is hungry, etc. The Virtual Assistant acts like a real human being, according to the preferences, which are set by the user. In addition, the user can set mood of the Virtual Assistant (angry, happy, etc.) for having fun, for example, when searching the database. The Virtual Assistant can talk with the user using high language phrases or using street slang. For enabling the Virtual Assistant to make an intelligent communication with the user, various artificial intelligence algorithms and techniques can be used, based for example on neural networks, decision making algorithms and techniques, and many others.

The user can switch the video search to the voice search (wherein the user provides queries by voice) by pressing link 101 “Switch to a voice/audio search”. Similarly, the user can switch to a conventional textual search by pressing link 106 “Switch to a textual search”. In addition, the user can disconnect his Web camera from the search engine User Interface by pressing the corresponding link “Disconnect my Web camera” 107.

FIG. 1D is a schematic illustration 165 of conducting a voice search within a database over a data network by using a Virtual Assistant 125 implemented within an intelligent User Interface, and of advertising by using the same, according to a preferred embodiment of the present invention. The user searching for tennis courts can say, for example, “I am looking for tennis courts in California”. One or more software components installed within the search engine server and/or within user's computer analyze user's query and process it. The search engine searches his database for the relevant search results and then presents them to the user in an audio/voice, video, picture/image/photo or textual form. The user makes a conversation with a search engine, as he makes a conversation with a human being. In should be noted that the user can set the language by which the search engine “speaks” with him.

According to a preferred embodiment of the present invention, the user can conduct an audio search. For example, the user has a song or melody and he is interested to know its compositor. The user plays this song or melody to the search engine using, for example, his microphone, and then the user receives the compositor name along with other details, such as the name of said song or melody, the date of compositing said song or melody, etc. The user is provided with advertisements, such as Sponsored Links 310 related to said song or melody, or related to music in general. Said advertisements can be provided by voice (speech) and/or as the audio data, by displaying video and/or graphic, image, picture, photo, icon, logo or textual information, or by providing a data file, such as video, voice, multimedia file comprising data related to said advertisements. For example, the user can be provided with a textual link 315 “Tennis courts in San-Francisco www.domainforexample2.com”; a video link 316; an audio/voice link 317; and a picture/image/photo/icon/logo link 318.

According to another preferred embodiment of the present invention, the user when conducting a voice search is presented with visual contents, such as a Virtual Assistant in a form of talking mouth 125. This preferred embodiment is more applicable for a user who set the search engine communication language (by which the search engine “speaks” with him), which he does not understand properly. For example, the user from Japan searching for pubs in Boston, United States of America (USA) within USA web sites can receive search results in the English language. It will be easier for him to understand spoken English if he sees talking mouth 125 pronouncing each spoken word. It should be noted that according to a preferred embodiment of the present invention, the search results can be translated to any language prior being presented/announced to the user. In addition, this preferred embodiment is also more applicable for deaf people, whose hearing is weak or absent at all. By watching talking mouth 125, the deaf people can understand search engine speech more properly.

According to a preferred embodiment of the present invention, the search engine can ask (by voice; presenting to a user video or textual data) a user a number of questions related to the user's search query, and by analyzing and processing user's answer(s) search engine can select the most appropriate search result(s) from a list of obtained search results 120. The user can communicate with the search engine as with a human being, since Virtual Assistant 125 of said search engine behaves as the human being. The search engine analyzes user's voice queries, commands, answers and the like by means of one or more speech recognition components, which are installed within search engine server and/or user's computer. Then, one or more software components, which can have an artificial intelligence, process received data and ask the user by means of Virtual Assistant 125 one or more questions that help to determine the most appropriate search result for user's one or more search queries. According to another preferred embodiment of the present invention, Virtual Assistant 125 instead of asking the user a number of questions (by voice or by presenting textual data) related to the user's one or more search queries, can present to said user an image, a photo, a video film, and any other data for determining whether this data is related to said user's search query. It can help to said Virtual Assistant 125 to obtain more precise search results for user's said one or more search queries and can help to provide to the user more appropriate advertisements, such as Sponsored Links. Said advertisements can be provided by voice (speech) and/or audio data, by displaying video and/or graphic, image, picture, photo, icon, logo or textual information, or by providing a data file, such as video, voice, multimedia file comprising data of said advertisements.

The user can switch the voice search to the video search by pressing link 102 “Switch to a video search”. Similarly, the user can switch to a conventional textual search by pressing link 106 “Switch to a textual search”. In addition, the user can connect his Web camera to the search engine User Interface for providing video data and conducting the search by pressing the corresponding link “Connect my Web camera” 104.

FIG. 1E is a schematic illustration 170 of conducting an optimized data search within a database over a data network by using an intelligent User Interface and enabling a user to use a data file related to his search (enabling a user to make a “data file search”), and of advertising by using the same, according to a preferred embodiment of the present invention. For example, a user has a file with a painting of Van Gogh and he wishes to know the name of said painting and the date it was painted. Then, he inputs the file (e.g., a “.jpg” or “.gif” file) with said painting by pressing link 171. One or more software components installed on the search engine server and/or installed on user's computer analyze and process said file by using a conventional or dedicated algorithm(s). Other one or more software components within the search engine, search the database for obtaining one or more relevant search results, and then provide these results to the user by means of the User Interface. Based on user's one or more search queries (voice and/or audio and/or video, etc. search queries) and/or on contents of the discussion between the user and the Virtual Assistant and/or on user's answers to said one or more questions, a number of Sponsored Links 310 is provided.

According to a preferred embodiment of the present invention, Sponsored Links 310 can be provided to the user by voice (speech) and/or by audio data, by displaying video and/or graphic, image, picture, photo, icon, logo or textual information, or by providing a data file, such as video, voice, multimedia file comprising data of said Sponsored Links 310. The user when clicking or responding (for example, by voice, by making a visual sign, such as a positive/negative nod of his head, etc.) to each provided Sponsored Link is redirected to a document related to the advertised product, service or anything else. Each time the user clicks or responds to said “Sponsored Link”, the advertiser pays a predetermined sum of money to the search engine provider. The more clicks or responses are provided by the users at the search engine Web site, the larger monetary income is obtained by the search engine provider. Alternatively, the search engine provider can charge from the advertiser a fixed daily or monthly price for each “Sponsored Link” provided to the search engine user.

For another example, the user has an audio file of a sonata, and he wishes to determine who is a compositor of said sonata. Then, he inputs said audio file by pressing a link 171. One or more software components installed on the search engine server and/or installed on the user's computer analyze and process said file by using a conventional or dedicated algorithm(s). Other one or more software components within the search engine, search the database for obtaining one or more relevant search results, and then provide these results to the user by means of the User Interface.

For still another example, the user has a video film, wherein a painting exhibition in England is recorded. The user wishes to determine the date of said exhibition. He inputs said file by pressing link 171. One or more software components installed on the search engine server and/or installed on the user's computer analyze and process said file by using a conventional or dedicated algorithm(s). Other one or more software components within the search engine search the database for obtaining one or more relevant search results, and then provide these results to the user by means of the User Interface.

According to a preferred embodiment of the present invention, the user can combine different search options for conducting a search. For example, he can input a text query in text field 105 along with inserting a file by pressing link 171. Each search option (video search, audio search, etc.) complements another search option by providing additional information. For example, a user wishing to determine a name of a Van Gogh painting and the date said painting was painted, can input a textual query, such as “Name and Date” and in addition to input an image/photo file (e.g., a “.jpg” or “.gif” file) comprising said painting. Similarly, instead of inputting the text query, the user can input said query by voice, conducting a voice search in addition to inputting the file with said painting.

It should be noted that according to a preferred embodiments of the present invention, one or more software components installed on the search engine server and/or installed on the user's computer can use OCR (Optical Character Recognition) algorithm(s) and technique(s) for recognizing data inputted by the user. In addition, the above one or more software components can use speech recognition algorithm(s) and technique(s) for recognizing user's voice/audio search queries.

FIG. 2 is a schematic illustration of system 200 for conducting optimized data searches within a database over a data network by using an intelligent User Interface having a Virtual Assistant 125 (FIG. 1B), and for advertising by using the same, according to a preferred embodiment of the present invention. System 200 comprises a plurality of computers 205 and a server 255 of a search engine/database provider. Computers 205 are connected to server 255 via a data network, such as the Internet, LAN (Local Area Network), Ethernet, Intranet, wireless (mobile) network, cable network, satellite network and any other network. Each computer 205 comprises processing means (processor) 215, such as the CPU (Central Processing Unit), DSP (Digital Signal Processor), microprocessor, etc. with one or more memory units for processing data; User Interface 217 for enabling a user to conduct a data search within a database 228 by receiving from said user one or more search queries and presenting to said user one or more search results, said User Interface communicating with said user by means of Virtual Assistant 125 for helping said user to obtain said one or more search results; and one or more software components 216 for analyzing and processing said one or more search queries, for enabling said Virtual Assistant to communicate with said user, and for processing the one or more search results for said one or more search queries. In addition, each computer 205 can comprise a camera 218, such as a Web camera for providing video data 130 (FIG. 1C) to search engine server 225.

Server 255 of a search engine/database provider comprises processing means (processor) 226, such as the CPU (Central Processing Unit), DSP (Digital Signal Processor), microprocessor, etc. with one or more memory units for processing data; a search data database 228 for storing a plurality of documents; an advertisements database 229 for storing a plurality of advertisers' advertisements, such as Sponsored Links, etc.; one or more software components 227 for managing and maintaining said databases, and enabling users to conduct searches within database 228; and a billing system 230 for billing advertisers for their advertisements provided to search engine users. Each time the search engine user clicks or responds (for example, by voice, by making a visual sign, such as a positive/negative nod of his head, etc.) to the “Sponsored Link” (provided to him by voice (speech) and/or by announcing audio data, by displaying video and/or graphic, image, picture, photo, icon, logo or textual information, or by providing a data file, such as video, voice, multimedia file comprising data of said Sponsored Links), the advertiser pays a predetermined sum of money to the search engine provider. The more clicks or responses are provided by users of the search engine Web site, the larger monetary income is obtained by the search engine provider. Alternatively, the search engine provider can charge the advertiser a fixed daily or monthly sum of money for each “Sponsored Link” provided (presented visually or audibly) to the search engine user.

One or more software components 216 and/or one or more software components 227 can comprise artificial intelligence algorithms and techniques for implementing Virtual Assistant 125, said artificial intelligence can be based, for example, on neural computing (neural networks); can implement different decision making algorithms and techniques; can implement case-based reasoning; can implement natural language processing (pattern matching, syntactic and semantic analysis, neural computing, conceptual dependency, etc.) and speech/audio recognition and understanding algorithms and techniques; can implement visual recognition algorithms and techniques; can use intelligent agents; can implement fuzzy logic, genetic algorithms and techniques, automatic programming, computer vision, and many others allowing the user to interact with a computer-based system in the same way (or in much the same way) as he would converse with another human being. One or more software components 216 and/or one or more software components 227 can further implement various machine learning algorithms and techniques.

FIG. 3 is another schematic illustration 300 of conducting an optimized data search within a database over a data network by using an intelligent User Interface having a Virtual Assistant 125 (FIG. 1B), and of advertising by using the same, according to another preferred embodiment of the present invention. It is supposed, for example, that a user searches for tennis courts. Each document within the database can have one or more voice and/or video and/or textual users' reviews with scores, helping a user to decide whether each document within search results list 120 is relevant and sufficient for his search query “tennis courts”. If one or more reviews of a document and/or a corresponding score of users' reviews that can be displayed near links 122, 123 and 124 indicate that said document is not relevant for the user's search query, the user does not need to open said document and he can skip it. The Virtual Assistant of the search engine can help the user to decide whether each document within search results list 120 is relevant and sufficient for his search query by providing one or more recommendations (advertisements) for said each document. Such advertisements of Virtual Assistant 125 can be based on the above reviews and/or scores of said reviews. Virtual Assistant 125 can provide advertisements by voice and/or by presenting to the user video, audio, graphics, photo, image and the like data In addition, Virtual Assistant 125 can make advertisements to the user by providing him a file, such as a multimedia, textual, audio and/or video file.

In addition, prior to clicking or responding to each Sponsored Link within one or more Sponsored Links 310, the user can also be presented with corresponding voice, video or textual reviews by pressing on links 122, 123, or 124, respectively. According to another preferred embodiment of the present invention, the user can also be presented with said corresponding voice, video or textual reviews only by moving a mouse cursor (without a need to make a click) to each one of links 122, 123, or 124, respectively. In addition, the user can write and/or record his one or more reviews by voice and/or by video by clicking (or selecting) on link 126.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for conducting a data search within a database over a data network, comprising:
a. a user interface having a virtual assistant for communicating with a user, for receiving from said user one or more search queries and for providing to said user one or more corresponding search results from said database; and
b. one or more software components installed on a server connected to said database and/or installed on a user's computer for:
b.1. enabling said virtual assistant to communicate with said user;
b.2. analyzing and processing said one or more search queries for obtaining corresponding search results; and
b.3. processing said one or more search results and providing them to said user.

2. A system for providing one or more advertisements to a user conducting a data search within a database over a data network, comprising:
a. a user interface having a virtual assistant for communicating with a user, for receiving from said user one or more search queries and for providing to said user one or more advertisements related to his one or more search queries; and
b. one or more software components installed on a server connected to said database and/or installed on a user's computer for:
b.1. enabling said virtual assistant to communicate with said user;
b.2. analyzing and processing said one or more search queries for obtaining corresponding one or more advertisements; and
b.3. processing said one or more advertisements related to said one or more search queries and providing them to said user.

3. System according to claim 1 or 2, wherein the data search is selected from one or more of the following:
a. a video search;
b. a graphic, image, picture, photo, icon or logo search;
c. a voice search;
d. an audio search;
e. a data file search; and
f. a textual search.

4. System according to claim 2, wherein the one or more advertisements are selected from one or more of the following:
a. a video advertisement;
b. a graphic, image, picture, photo, icon or logo advertisement;
c. a voice advertisement;
d. an audio advertisement;
e. a data file advertisement; and
f. a textual advertisement.

5. System according to claim 2, wherein the one or more advertisements are provided according to a category or subcategory of the one or more search queries.

6. System according to claim 2, wherein the one or more advertisements are provided according to a category or subcategory of one or more search results for user's one or more search queries.

7. System according to claim 1 or 2, wherein the virtual assistant communicates with the user by presenting to him data selected from one or more of the following:
a. voice data;
b. audio data;
c. video data;
d. image, picture, photo, graphic, icon or logo data; and
e. textual data.

8. System according to claim 7, wherein the virtual assistant receives a response from the user to the presented data and provides to said user the one or more advertisements based on said response.

9. System according to claim 1 or 2, wherein the one or more software components use one or more members within the group, comprising:
a. speech recognition;
b. audio recognition;
c. visual recognition;
d. OCR recognition;
e. object recognition; and
f. face recognition.

10. System according to claim 1 or 2, wherein the one or more user's search queries are provided by means of a camera connected to the data network.

11. System according to claim 10, wherein the virtual assistant determines user's characteristics and/or user's mood by means of the camera.

12. System according to claim 10, wherein the virtual assistant determines objects and their one or more characteristics by means of the camera, said objects physically located within the space where the user searches the database.

13. System according to claim 10, wherein the camera field of view is not constant and is changing for determining objects within the space, wherein the user searches the database.

14. System according to claim 10, wherein a search engine provider controls the field of view of each camera, connected to the data network, by means of one or more software and/or hardware components or units.

15. System according to claim 1 or 2, wherein the one or more user's search queries are provided as data files.

16. System according to claim 2, wherein the virtual assistant makes the one or more advertisements to the user based on other users' one or more reviews.

17. System according to claim 1 or 2, wherein the user prior to conducting the data search within the database, discusses with the virtual assistant one or more issues related to said data search.

18. System according to claim 1, wherein the user writes and/or records a review for each document within the one or more search results.

19. System according to claim 1 or 2, wherein the virtual assistant is implemented by utilizing artificial intelligence.

20. System according to claim 19, wherein the artificial intelligence utilizes one or more members within the group, comprising:
a. one or more neural networks;
b. one or more decision making algorithms and techniques;
c. case-based reasoning;
d. natural language processing;
e. speech recognition;
f. one or more understanding algorithms and techniques;
g. one or more visual recognition algorithms and techniques;
h. one or more intelligent agents;
i. one or more machine learning algorithms and techniques;
j. fuzzy logic;
k. one or more genetic algorithms and techniques;
l. automatic programming; and
m. computer vision.

21. System according to claim 1 or 2, wherein the virtual assistant discusses with the user one or more documents within the one or more search results, or reads, or shows to the user data related to each document, said data based on contents of each corresponding document or based on the contents of a site to which said each corresponding document is related.

22. System according to claim 1 or 2, wherein the user interface is the artificial intelligence based interface allowing the user to interact with a computer-based system similarly to conversing with a human being.

23. System according to claim 1 or 2, wherein the user sets one or more preferences of the virtual assistant.

24. System according to claim 1 or 2, wherein the virtual assistant provides to the user data related to each document within the database, said data selected from one or more of the following: (a) anchor text; (b) category; (c) wording; (d) textual data; (e) graphical data; (f) URL parameters; (g) creation data; (h) update data; (i) author data; (j) meta data; (k) owner data; (l) statistic data; (m) history data; (n) one or more votes for said document; and (o) probability.

25. System according to claim 24, wherein the history data is selected from one or more of the following: (a) content(s) update(s) or change(s); (b) creation date(s); (c) ranking history; (d) categorized ranking history; (e) traffic data history; (f) query(is) analysis history; (g) user behavior history; (h) URL data history; (i) user maintained or generated data history; (j) unique word(s) usage history; (k) bigram(s) history; (l) phrase(s) in anchor text usage history; (m) linkage of an independent peer(s) history; (n) document topic(s) history; (o) anchor text content(s) history; and (p) meta data history.

26. A system for providing one or more advertisements to a user conducting a data search within a database over a data network, comprising:
a. a camera for shooting a user and/or his environment and obtaining corresponding visual data;
b. one or more software components for receiving the obtained visual data and processing it; and
c. one or more software components for providing one or more advertisements to said user according to said obtained visual data.

27. A system for communicating with a user over a data network by means of a virtual assistant and providing to said user one or more advertisements, comprising:
a. a camera for shooting a user and/or his environment and obtaining corresponding visual data;
b. one or more software components for receiving the obtained visual data and processing it; and
c. a virtual assistant for communicating with said user and providing to said user one or more advertisements according to said obtained visual data.

28. System according to claim 26 or 27, wherein the visual data relates to a visual appearance of the user.

29. System according to claim 26 or 27, wherein the visual data relates to one or more objects located in the camera field of view.

30. System according to claim 26 or 27, wherein the visual data relates to mood of the user.

31. System according to claim 26 or 27, wherein the visual data relates to user's one or more characteristics.

32. System according to any of claims 10, 26 or 27, wherein a type of the camera is selected from one or more of the following:
a. a video camera;
b. a photo camera;
c. an Infrared camera;
d. an ultraviolet camera; and
e. a thermal camera.

33. System according to any of claims 1, 2, 26 or 27, wherein the virtual assistant is implemented by software and/or hardware.

34. System according to claim 2 or 27, wherein the user responds to the one or more advertisements by one or more of the following:
a. a visual response;
b. a voice response;
c. an audio response;
d. a textual response; and
e. a data file response.

35. A method for conducting a data search within a database over a data network, comprising:
a. providing a user interface having a virtual assistant for communicating with a user, for receiving from said user one or more search queries and for providing to said user one or more corresponding search results from said database; and
b. providing one or more software components installed on a server connected to said database and/or installed on a user's computer for:
b.1. enabling said virtual assistant to communicate with said user;
b.2. analyzing and processing said one or more search queries for obtaining corresponding search results; and
b.3. processing said one or more search results and providing them to said user.

36. A method for providing one or more advertisements to a user conducting a data search within a database over a data network, comprising:
a. providing a user interface having a virtual assistant for communicating with a user, for receiving from said user one or more search queries and for providing to said user one or more advertisements related to his one or more search queries; and
b. providing one or more software components installed on a server connected to said database and/or installed on a user's computer for:
b.1. enabling said virtual assistant to communicate with said user;
b.2. analyzing and processing said one or more search queries for obtaining corresponding one or more advertisements; and
b.3. processing said one or more advertisements related to said one or more search queries and providing them to said user.

37. Method according to claim 35 or 36, further comprising selecting the data search from one or more of the following:
a. a video search;
b. a graphic, image, picture, photo, icon or logo search;
c. a voice search;
d. an audio search;
e. a data file search; and
f. a textual search.

38. Method according to claim 36, further comprising selecting the one or more advertisements from one or more members within the group, comprising:
a. a video advertisement;
b. a graphic, image, picture, photo, icon or logo advertisement;
c. a voice advertisement;
d. an audio advertisement;
e. a data file advertisement; and
f. a textual advertisement.

39. Method according to claim 36, further comprising providing the one or more advertisements according to a category or subcategory of the one or more search queries.

40. Method according to claim 36, further comprising providing the one or more advertisements according to a category or subcategory of one or more search results for user's one or more search quires.

41. Method according to claim 35 or 36, further comprising communicating with the user by means of the virtual assistant by presenting to him data selected from one or more of the following:
a. voice data;
b. audio data;
c. video data;
d. image, picture, photo, graphic, icon or logo data; and
e. textual data.

42. Method according to claim 41, further comprising receiving a response from the user to the presented data and providing to said user the one or more advertisements based on said response.

43. Method according to claim 35 or 36, further comprising implementing by means of the one or more software components one or more members within the group, comprising:
a. speech recognition;
b. audio recognition;
c. visual recognition;
d. OCR recognition;
e. object recognition; and
f. face recognition.

44. Method according to claim 35 or 36, further comprising providing the one or more user's search queries by means of a camera connected to the data network.

45. Method according to claim 44, further comprising determining user's characteristics and/or user's mood by means of the camera.

46. Method according to claim 44, further comprising determining objects and their one or more characteristics by means of the camera, said objects physically located within the space where the user searches the database.

47. Method according to claim 44, further comprising changing the camera field of view for determining objects within the space, wherein the user searches the database.

48. Method according to claim 44, further comprising controlling by a search engine provider the field of view of each camera, connected to the data network, using one or more software and/or hardware components or units.

49. Method according to claim 35 or 36, further comprising providing the one or more user's search queries as data files.

50. Method according to claim 36, further comprising providing the one or more advertisements to the user based on other users' one or more reviews.

51. Method according to claim 35 or 36, further comprising discussing with the user by the virtual assistant one or more issues related to the data search, prior to conducting said data search within the database.

52. Method according to claim 35, further comprising enabling the user to write and/or to record a review for each document within the one or more search results.

53. Method according to claim 35 or 36, further comprising implementing the virtual assistant by utilizing artificial intelligence.

54. Method according to claim 53, further comprising utilizing the artificial intelligence by one or more members within the group, comprising:
a. one or more neural networks;
b. one or more decision making algorithms and techniques;
c. case-based reasoning;
d. natural language processing;
e. speech recognition;
f. one or more understanding algorithms and techniques;
g. one or more visual recognition algorithms and techniques;
h. one or more intelligent agents;
i. one or more machine learning algorithms and techniques;
j. fuzzy logic;
k. one or more genetic algorithms and techniques;
automatic programming; and
m. computer vision.

55. Method according to claim 35 or 36, further comprising discussing with the user by the virtual assistant one or more documents within the one or more search results, or reading, or showing to the user data related to each document, said data based on contents of each corresponding document or based on the contents of a site to which said each corresponding document is related.

56. Method according to claim 35 or 36, further comprising providing the user interface as the artificial intelligence based interface, allowing the user to interact with a computer-based system in the same way or in much the same way as he converses with another human being.

57. Method according to claim 35 or 36, further comprising setting by the user one or more preferences of the virtual assistant.

58. Method according to claim 35 or 36, further comprising providing to the user data related to each document within the database, said data selected from one or more of the following: (a) anchor text; (b) category; (c) wording; (d) textual data; (e) graphical data; (f) URL parameters; (g) creation data; (h) update data; (i) author data; (j) meta data; (k) owner data; (l) statistic data; (m) history data; (n) one or more votes for said document; and (o) probability.

59. Method according to claim 58, further comprising providing the history data from one or more of the following: (a) content(s) update(s) or change(s); (b) creation date(s); (c) ranking history; (d) categorized ranking history; (e) traffic data history; (f) query(is) analysis history; (g) user behavior history; (h) URL data history; (i) user maintained or generated data history; (j) unique word(s) usage history; (k) bigram(s) history; (l) phrase(s) in anchor text usage history; (m) linkage of an independent peer(s) history; (n) document topic(s) history; (o) anchor text content(s) history; and (p) meta data history.

60. A method for providing one or more advertisements to a user conducting a data search within a database over a data network, comprising:
a. providing a camera for shooting a user and/or his environment and obtaining corresponding visual data;
b. providing one or more software components for receiving the obtained visual data and processing it; and
c. providing one or more software components for providing one or more advertisements to said user according to said obtained visual data.

61. A method for communicating with a user over a data network by means of a virtual assistant and for providing to said user one or more advertisements, comprising:
a. providing a camera for shooting a user and/or his environment and obtaining corresponding visual data;
b. providing one or more software components for receiving the obtained visual data and processing it; and
c. providing a virtual assistant for communicating with said user and providing to said user one or more advertisements according to said obtained visual data.

62. Method according to claim 60 or 61, further comprising providing a visual appearance of the user as the visual data.

63. Method according to claim 60 or 61, further comprising providing one or more objects located in the camera field of view as the visual data.

64. Method according to claim 60 or 61, further comprising providing mood of the user as the visual data.

65. Method according to claim 60 or 61, further comprising providing user's one or more characteristics as the visual data.

66. Method according to any of claims 44, 60 or 61, further comprising selecting a type of the camera from one or more members within the group, comprising:
a. a video camera;
b. a photo camera;
c. an Infrared camera;
d. an ultraviolet camera; and
e. a thermal camera.

67. Method according to any of claims 35, 36, 60 or 61, further comprising implementing the virtual assistant by software and/or hardware.

68. Method according to claim 36 or 61, further comprising responding by the user to the one or more advertisements by one or more of the following:
a. a visual response;
b. a voice response;
c. an audio response;
d. a textual response; and
e. a data file response.

69. System according to any of claims 1, 2, 26 or 27, which is a search engine.

70. Use of a system according to any of claims 1, 2, 26 or 27, as a search engine.

71. Use according to any of claims 1, 2, 26 or 27, wherein the system is a search engine.
